(19) United States
(12) Patent Application Publication
(10) Pub. No.: US 2016/0085724 A1
(43) Pub. Date: Mar. 24, 2016

(54) LIFE TIME ESTIMATION DEVICE AND METHOD

(71) Applicant: KABUSHIKI KAISHA TOSHIBA, Tokyo (JP)

(72) Inventor: Gaku ISHII, Kawasaki (JP)

(21) Appl. No.: 14/856,060

(22) Filed: Sep. 16, 2015

(30) Foreign Application Priority Data
Sep. 19, 2014 (JP) 2014-191709

(51) Int. Cl. G06F 17/18

(52) U.S. Cl. CPC G06F 17/18

(57) ABSTRACT

A life time estimation device according to an embodiment includes a benchmark work amount calculator, an assumed work amount calculator, an assumed load coefficient calculator, an assumed environment coefficient calculator, and an assumed life time calculator. The benchmark work amount calculator calculates a benchmark work amount of a target apparatus based on a design condition. The assumed work amount calculator calculates an assumed work amount of the target apparatus based on a load condition. The assumed load coefficient calculator calculates an assumed load coefficient indicating a degree of an operation load on the target apparatus based on the benchmark work amount and the assumed work amount. The assumed environment coefficient calculator calculates an assumed environment coefficient based on an environmental condition. The assumed life time calculator calculates an assumed life time of the target apparatus based on the assumed load coefficient and the assumed environment coefficient.

### CROSS REFERENCE TO RELATED APPLICATION (S)

This application is based upon and claims the benefit of priority from the prior Japanese Patent Application No. 2014-191709, filed on Sep. 19, 2014, the entire contents of which are incorporated herein by reference.

### FIELD

Embodiments described herein relate generally to a life time estimation device and a method.

### BACKGROUND

Local infrastructures constructed during the high economic growth period in Japan need to be replaced, and demands in the society have been changing from new construction to maintenance, repair, and replacement of these facilities or equipment. With this change, a sense of values has been focusing on “recreation” than “new creation”.

When land redevelopment, or renovation of buildings or factories is performed, installation of a new apparatus system or reconstruction, such as improvement and replacement, of an existing apparatus system is performed. How the reconstruction is performed is determined comparing investment effectiveness of reconstruction plans at a planning stage. Therefore, in reconstruction of an apparatus system, when an existing apparatus system continuously operates or is replaced, or when a new apparatus system is installed, it is important to quantitatively estimate life cycle costs (initial costs+maintenance costs+disposal costs) of the apparatus system.

Furthermore, in order to estimate life cycle costs, it is necessary to understand operation conditions, such as usage or an installation environment at a site or in a building, of an apparatus system. This is because that maintenance costs depend on a life time of the apparatus system and the life time is greatly changed according to the operation conditions. Currently, a design condition value given by a manufacturer of an apparatus system is expediently applied to a life time.

However, the above design condition value is a life time under particular conditions assumed by a manufacturer of an apparatus system, and most of the conditions are different from the operation conditions at a redevelopment site or in a renovated building. Furthermore, when the apparatus system is used more than the assumption of the manufacturer or installed in a harsh environment, the design condition value may be underestimated as a consequence. Moreover, a use or a way to use of an apparatus system is frequently changed due to redevelopment or renovation, and operation results or empirical rules of an existing apparatus system cannot be simply applied. In addition, when a new apparatus system is installed, there exist no operation results in the installation environment nor empirical rules of the apparatus system.

Consequently, a method for estimating life cycle costs by using a design condition value as a life time has a risk of errors between the reality and the assumption, and it may cause a wrong determination of a design or investment.

### BRIEF DESCRIPTION OF THE DRAWINGS

FIG. 1 is a block diagram showing a functional configuration of a life time estimation device according to a first embodiment;

FIG. 2 is a diagram showing an example of load factor data;

FIG. 3 is a diagram showing a hardware configuration of the life time estimation device of FIG. 1;

FIG. 4 is a flowchart showing operation of the life time estimation device of FIG. 1;

FIG. 5 is a flowchart showing assumed load coefficient calculation processing of the life time estimation device of FIG. 1;

FIG. 6 is a flowchart showing assumed environment coefficient calculation processing of the life time estimation device of FIG. 1;

FIG. 7 is a block diagram showing a functional configuration of a life time estimation device according to a second embodiment;

FIG. 8 is a flowchart showing assumed load coefficient calculation processing of the life time estimation device of FIG. 7;

FIG. 9 is a flowchart showing assumed environment coefficient calculation processing of the life time estimation device of FIG. 7;

FIG. 10 is a block diagram showing a functional configuration of a life time estimation device according to a third embodiment;

FIG. 11 is a flowchart showing operation of the life time estimation device of FIG. 10;

FIG. 12 is a flowchart showing real load coefficient calculation processing of the life time estimation device of FIG. 10; and

FIG. 13 is a flowchart showing real environment coefficient calculation processing of the life time estimation device of FIG. 10.

### DETAILED DESCRIPTION

Embodiments will now be explained with reference to the accompanying drawings. The present invention is not limited to the embodiments.

A life time estimation device according to an embodiment includes a benchmark work amount calculator, an assumed work amount calculator, an assumed load coefficient calculator, an assumed environment coefficient calculator, and an assumed life time calculator. The benchmark work amount calculator calculates a benchmark work amount of a target apparatus based on a design condition. The assumed work amount calculator calculates an assumed work amount of the target apparatus based on a load condition. The assumed load coefficient calculator calculates an assumed load coefficient indicating a degree of an operation load on the target apparatus based on the benchmark work amount and the assumed work amount. The assumed environment coefficient calculator calculates an assumed environment coefficient indicating a degree of an environmental load on the target apparatus based on an environmental condition. The assumed life time calculator calculates an assumed life time of the target apparatus based on the assumed load coefficient and the assumed environment coefficient.

### First Embodiment

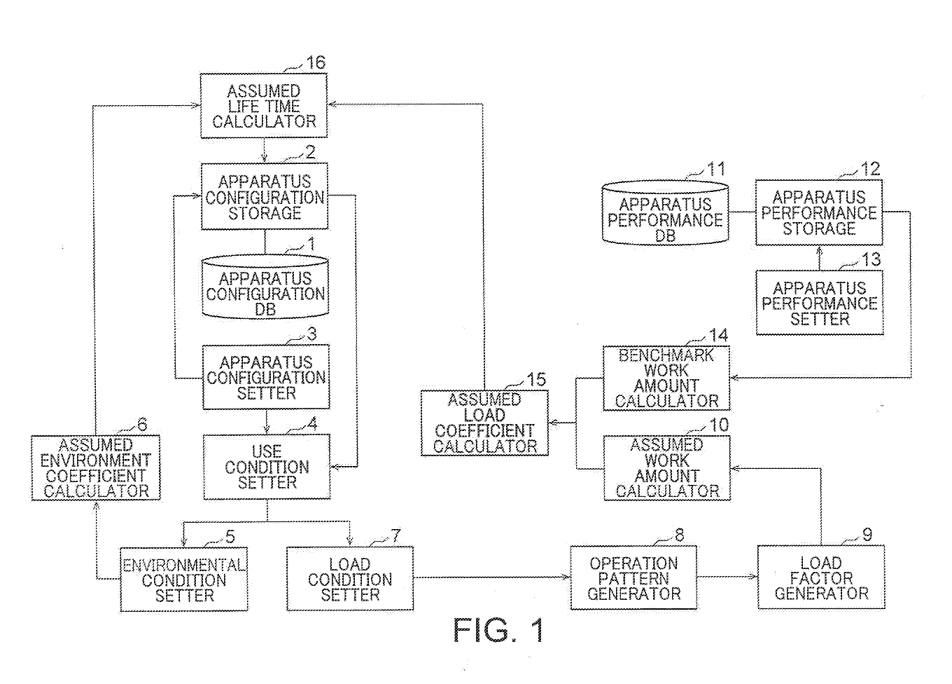

A life time estimation device (hereinafter, referred to as an “estimation device”) and a method according to a first embodiment will be described with reference to FIGS. 1 to 6. The estimation device and the method according to the present embodiment estimate a life time of an apparatus based on a load condition and an environmental condition of the apparatus. Hereinafter, an apparatus as a life time estimation target is referred to as a target apparatus. The target apparatus includes a single apparatus, an apparatus system configured with a plurality of apparatuses, and the components of them.

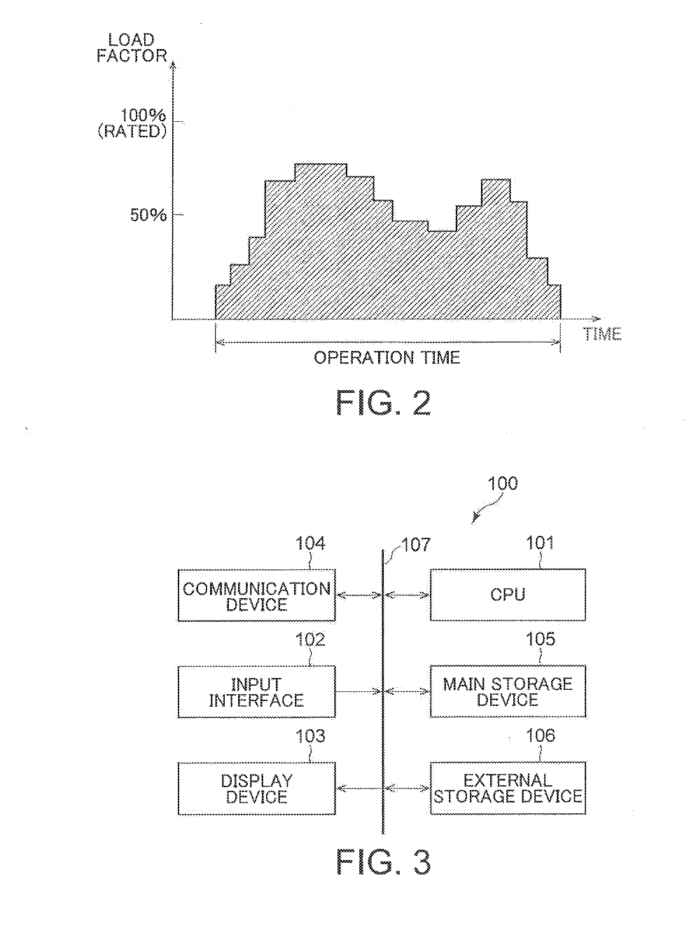

First, a functional configuration of the estimation device according to the present embodiment will be described with reference to FIGS. 1 and 2. FIG. 1 is a block diagram showing a functional configuration of the estimation device according to the present embodiment. As shown in FIG. 1, the estimation device includes an apparatus configuration DB 1, an apparatus configuration storage 2, an apparatus configuration setter 3, a use condition setter 4, an environmental condition setter 5, an assumed environment coefficient calculator 6, a load condition setter 7, an operation pattern generator 8, a load factor data generator 9, an assumed work amount calculator 10, an apparatus performance DB 11, an apparatus performance storage 12, an apparatus performance setter 13, a benchmark work amount calculator 14, an assumed load coefficient calculator 15, and an assumed life time calculator 16.

The apparatus configuration DB 1 is a storage medium which stores target apparatus information to specify the target apparatus. The target apparatus information includes, for example, but is not limited to, a type name, a product name, a model name, and a manufacturer of the target apparatus. A unique ID is assigned to each of the target apparatus information in units of execution to calculate the assumed life time (for example, in units of a case, such as an evaluation case, or an introduction/installation case). The assumed life time is the life time of the target apparatus which is estimated by the estimation device. The apparatus configuration DB 1 may store one or more execution units of the target apparatus information and data indicating a relationship between the target apparatuses or between apparatuses constituting the target apparatus.

The apparatus configuration storage 2 acquires the information from the apparatus configuration DB 1 and stores the information in the apparatus configuration DB 1. The apparatus configuration storage 2 assigns, for example, an ID to the target apparatus information and stores the information in the apparatus configuration DB 1. Furthermore, the apparatus configuration storage 2 may include a function to extract the target apparatus information or the target apparatus which matches search criteria.

The apparatus configuration setter 3 sets the target apparatus information. The apparatus configuration setter 3 may set the target apparatus information based on information input by a user or information acquired from another prepared DB (for example, the apparatus performance DB 11). Furthermore, when the target apparatus is an apparatus system configured with a plurality of apparatuses, the apparatus configuration setter 3 may set, as a list, each of the apparatus constituting the apparatus system. The target apparatus information set by the apparatus configuration setter 3 is stored in the apparatus configuration DB 1 by the apparatus configuration storage 2.

The use condition setter 4 sets a use condition indicating a use of the target apparatus. The use condition is, for example, but is not limited to, information indicating a business category and a size of a facility in which the target apparatus is installed (such as a type of business, a site area, a floor area, and a capacity), information indicating a type of facility (such as an office, a school, a store, a factory, and a firm), and information indicating an installation purpose (for example, a required function). The use condition setter 4 may set the use condition based on information input by a user or information acquired from a prepared use condition template.

The environmental condition setter 5 sets an environmental condition indicating an installation environment of the target apparatus. The environmental condition is, for example, but is not limited to, information indicating a location environment (such as an indoor place, an outdoor place, a longitude, a latitude, an altitude, and weather characteristics) and information indicating an operation environment (such as a dustproof level, a dripproof level, and an inspection frequency). The environmental condition setter 5 may set the environmental condition based on information input by a user or information acquired from a prepared environmental condition template. Furthermore, the environmental condition setter 5 may set the environmental condition based on the use condition set by the use condition setter 4.

The assumed environment coefficient calculator 6 calculates an assumed environment coefficient. The assumed environment coefficient indicates an environmental load on the target apparatus under the environmental condition set by the environmental condition setter 5. The environmental load is a load on the target apparatus due to an installation environment.

The assumed environment coefficient calculator 6 extracts, based on the environmental condition set by the environmental condition setter 5, the environmental load from an environmental load template in which the environmental load for each of the environmental condition is set based on results or experiences, for example, as four for an indoor place and six for an outdoor place. Then, the assumed environment coefficient calculator 6 compares the extracted environmental load to a benchmark environmental load and can thereby calculate the environment coefficient of the target apparatus. For example, when the benchmark value of the environmental load is 5 and the target apparatus is installed in an indoor place, the assumed environment coefficient can be calculated as 0.8 (=⅘).

Furthermore, when an environment coefficient calculated from past results data of the target apparatus exists, the assumed environment coefficient calculator 6 may use the environment coefficient. Alternatively, an environment coefficient calculated from results data of another apparatus under a similar environmental condition exists, the assumed environment coefficient calculator 6 may calculate the environment coefficient of the target apparatus using the environment coefficient.

Moreover, when the target apparatus is an apparatus system configured with a plurality of apparatuses, the assumed environment coefficient calculator 6 calculates the assumed environment coefficient of each of the apparatus, and may calculate, as the assumed environment coefficient of the target apparatus, a statistic, such as a mean vale, a median value, and a probability distribution (such as a variance or a standard deviation) of the plural assumed environment coefficients. In this case, the assumed environment coefficient of the target apparatus may be plural coefficients of a first assumed environment coefficient (mean value), a second assumed environment coefficient (median value), a third assumed environment coefficient (a lower limit value of a confidence interval n %), and a fourth assumed environment coefficient (an upper limit value of a confidence interval n %). This is applicable when the target apparatus is an apparatus configured with a plurality of parts which can calculate each of the assumed environment coefficients.

The load condition setter 7 sets a load condition indicating an operation mode of the target apparatus. The load condition is, for example, but is not limited to, an operation time, an operation hour, an operation date/time, and a load factor. The load factor described here is a ratio of output of the target apparatus to a rated output.

The load condition setter 7 may set the load condition based on information input by a user or information acquired from a prepared load condition template. Furthermore, the load condition setter 7 may set the load condition based on the use condition set by the use condition setter 4.

The operation pattern generator 8 generates an operation pattern of the target apparatus during the operation time based on the load condition set by the load condition setter 7. The operation pattern indicates chronological changes of the operation modes and is generated as a data sequence of the load condition for every unit hour. The operation pattern generator 8 can simulate the operation pattern of the target apparatus during the operation time by using, for example, results data of the past operation pattern of the target apparatus or results data of the operation pattern of another apparatus under a similar load condition. Note that, when the load condition is set every unit hour by the load condition setter 7, the operation pattern generator 8 may not be included.

The load factor data generator 9 generates load factor data based on the operation pattern generated by the operation pattern generator 8. The load factor data indicates chronological changes of the load factor during the operation time as shown in FIG. 2. Note that, the load factor data generator 9 may generate the load factor data based on the load condition set by the load condition setter 7. In this case, the estimation device may not include the operation pattern generator 8.

The assumed work amount calculator 10 calculates an assumed work amount based on the load factor data generated by the load factor data generator 9. The assumed work amount is a work amount of the target apparatus which is assumed when the target apparatus operates in accordance with the load condition. The assumed work amount is calculated as a cumulative load factor during the operation time. Therefore, the assumed work amount equals to the shaded area in FIG. 2.

The apparatus performance DB 11 is a storage medium which stores a design condition (performance) of the target apparatus. The design condition is a mathematical model indicating, for example, but is not limited to, a standard operation time per unit time, a standard load factor, a standard life time, and performance characteristics of the target apparatus. The apparatus performance DB 11 may store the design condition for each of the target apparatus or for each of the apparatus constituting the target apparatus.

The apparatus performance storage 12 acquires the information from the apparatus performance DB 11 and stores the information in the apparatus performance DB 11. The apparatus performance storage 12 stores, for example, the design condition in the apparatus performance DB 11. Furthermore, the apparatus performance storage 12 may include a function to extract the design condition or the target apparatus which matches search criteria.

The apparatus performance setter 13 sets a design condition of the target apparatus. The apparatus performance setter 13 may set the design condition based on information input by a user or information acquired from another prepared DB (for example, the apparatus configuration DB 1). The design condition set by the apparatus performance setter 13 is stored in the apparatus performance DB 11 by the apparatus performance storage 12.

The benchmark work amount calculator 14 calculates a benchmark work amount of the target apparatus based on the design condition of the target apparatus. The benchmark work amount is a work amount of the target apparatus which is assumed when the target apparatus operates in accordance with the design condition. The benchmark work amount is calculated, for example, as a cumulative standard load factor during the life time set as the design condition. The benchmark work amount is used as a benchmark to evaluate the work amount of the target apparatus.

The assumed load coefficient calculator 15 calculates an assumed load coefficient. The assumed load coefficient indicates a degree of an operation load on the target apparatus under the load condition set by the load condition setter 7 or in the operation pattern generated by the operation pattern generator 8. The operation load is a load on the target apparatus due to the load condition or the operation pattern. It is considered that the life time of the target apparatus becomes shorter, as the operation load becomes larger.

The assumed load coefficient calculator 15 calculates, as an assumed load coefficient, a ratio of the assumed work amount to the benchmark work amount. When the standard life time for which the benchmark work amount is calculated is different from the operation time for which the assumed work amount is calculated, it is preferable that the assumed load coefficient calculator 15 calculates the assumed load coefficient after normalizing these times.

Furthermore, when the target apparatus is an apparatus system configured with a plurality of apparatuses, the assumed load coefficient calculator 15 calculates the assumed load coefficient of each of the apparatus and may calculate, as the assumed load coefficient of the target apparatus, a statistic, such as a mean vale, a median value, and a probability distribution (such as a variance or a standard deviation) of the plural assumed load coefficients. In this case, the assumed load coefficient of the target apparatus may be plural coefficients of a first assumed load coefficient (mean value), a second assumed load coefficient (median value), a third assumed load coefficient (a lower limit value of a confidence interval n %), and a fourth assumed load coefficient (an upper limit value of a confidence interval n %). This is applicable when the target apparatus is an apparatus configured with a plurality of parts which can calculate each of the assumed load coefficients.

The assumed life time calculator 16 calculates an assumed life time based on the standard life time, the assumed environment coefficient, and the assumed load coefficient of the target apparatus. The assumed life time is an estimated value of the life time of the target apparatus as described above. More specifically, the assumed life time calculator 16 calculates the assumed life time by dividing the standard life time by the assumed environment coefficient and the assumed load coefficient. In other words, the assumed life time calculator 16 calculates the assumed life time so that the assumed life time becomes shorter than the standard life time, as the environmental load or the operation load becomes larger. This is because it is considered that the life time becomes shorter, as the environmental load or the operation load becomes larger.

When a plurality of assumed environment coefficients or a plurality of assumed load coefficients exists, the assumed life time calculator 16 selects a coefficient to be used according to the purpose and calculates the assumed life time. The assumed life time calculator 16 calculates the assumed life time by using a first assumed environment variable and a first assumed load variable, when, for example, estimating the average tendency of the assumed life time. Furthermore, the assumed life time calculator 16 calculates the assumed life time by using a fourth assumed environment variable and a fourth assumed load variable, when loosely estimating the assumed life time. Moreover, the assumed life time calculator 16 calculates the assumed life time by using a third assumed environment variable and a third assumed load variable, when strictly estimating the assumed life time.

Furthermore, when the target apparatus is an apparatus system configured with a plurality of apparatuses, the assumed life time calculator 16 calculates the assumed life time of each of the apparatus and may calculate a mean value, a median value, and a minimum value of the assumed life times as the assumed life time of the target apparatus. Alternatively, when the configuration of the target apparatus has redundancy, such as duplexing or functional substituting, the assumed life time calculator 16 may calculate, as the assumed life time of the target apparatus, the maximum value of the assumed life time which is calculated within the range of the redundancy. This is applicable when the target apparatus is an apparatus configured with a plurality of parts which can calculate each of the assumed life time.

The assumed life time calculated by the assumed life time calculator 16 is stored, as the target apparatus information, in the apparatus configuration DB 1 by the apparatus configuration storage 2.

Next, a hardware configuration of the estimation device according to the present embodiment will be described with reference to FIG. 3. The estimation device according to the present embodiment is configured by a computer device 100 as shown in FIG. 3. The computer device 100 includes a central processing unit (CPU) 101, an input interface 102, a display device 103, a communication device 104, a main storage device 105, and an external storage device 106, and these are connected each other by a bus 107.

The CPU 101 executes a life time estimation program (hereinafter, referred to as an “estimation program”) on the main storage device 105. The estimation program is a program to implement the above described functional configurations of the estimation device. The CPU 101 executes the estimation program, whereby the functional configurations are implemented.

The input interface 102 inputs operation signals from an input device, such as a key board, a mouse, and a touch panel, to the estimation device. The input interface 102 is, for example, but is not limited to, an USB or the Ethernet. The apparatus configuration setter 3, the use condition setter 4, the environmental condition setter 5, the load condition setter 7, and the apparatus performance setter 13 can set, based on the operation signals input by the input interface 102, the apparatus configuration, the use condition, the environmental condition, the load condition, and the apparatus performance.

The display device 103 displays video signals output from the estimation device. The display device 103 is, for example, but is not limited to, a liquid crystal display (LCD), a cathode ray tube (CRT), and a plasma display panel (PDP).

The communication device 104 is used for the estimation device to communicate with an external device by wire or wireless. The communication device 104 is, for example, but is not limited to, a modem or a router. The apparatus configuration setter 3, the use condition setter 4, the environmental condition setter 5, the load condition setter 7, and the apparatus performance setter 13 can set, based on the information input by an external device via the communication device 104, the apparatus configuration, the use condition, the environmental condition, the load condition, and the apparatus performance.

The main storage device 105 stores the estimation program, the data required to execute the estimation program, and the data generated by executing the estimation program, when the estimation program is executed. The estimation program is expanded and executed on the main storage device 105. The main storage device 105 is, for example, but is not limited to, RAM, DRAM, and SRAM. The apparatus configuration DB 1 and the apparatus performance DB 11 are constructed on at least one of the main storage device 105 and the external storage device 106.

The external storage device 106 stores the estimation program, the data required to execute the estimation program, and the data generated by executing the estimation program. The program or the data is stored in the main storage device 105, when the estimation program is executed. The external storage device 106 is, for example, but is not limited to, a hard disk, an optical disk, flash memory, and a magnetic tape.

Note that, the estimation program may be preinstalled in the computer device 100 or stored in a storage medium such as a CD-ROM. Furthermore, the estimation program may be uploaded on the internet.

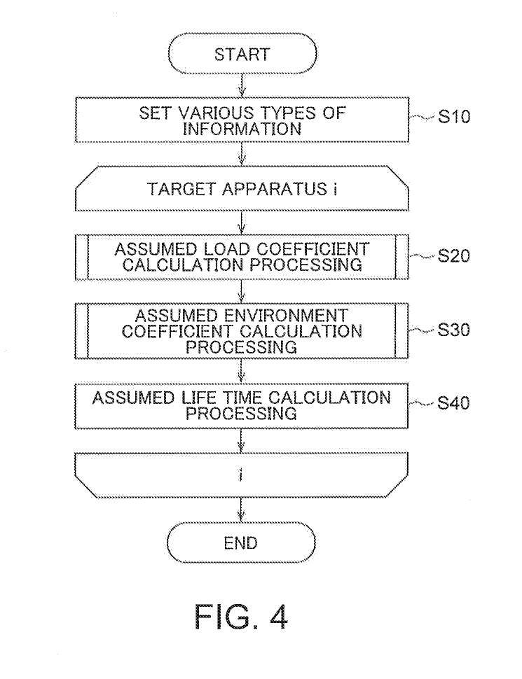

Next, the operation of the estimation device according to the present embodiment will be specifically described with reference to FIGS. 4 to 6. FIG. 4 is a flowchart showing an estimation method by the estimation device according to the present embodiment.

First, in step S10, various types of information are set. In other words, the apparatus configuration setter 3 sets the apparatus configuration of the target apparatus, the use condition setter 4 sets the use condition, the environmental condition setter 5 sets the environmental condition, the load condition setter 7 sets the load condition, and the apparatus performance setter 13 sets the apparatus performance of the target apparatus.

After the settings, assumed load coefficient calculation processing (step S20), assumed environment coefficient calculation processing (step S30), and assumed life time calculation processing (step S40) are performed. The processing from step S20 to step S40 is loop processing, and when a plurality of target apparatuses exists, the processing is performed to all of the target apparatuses. Furthermore, the assumed load coefficient calculation processing (step S20) and the assumed environment coefficient calculation processing (step S30) may reverse the order.

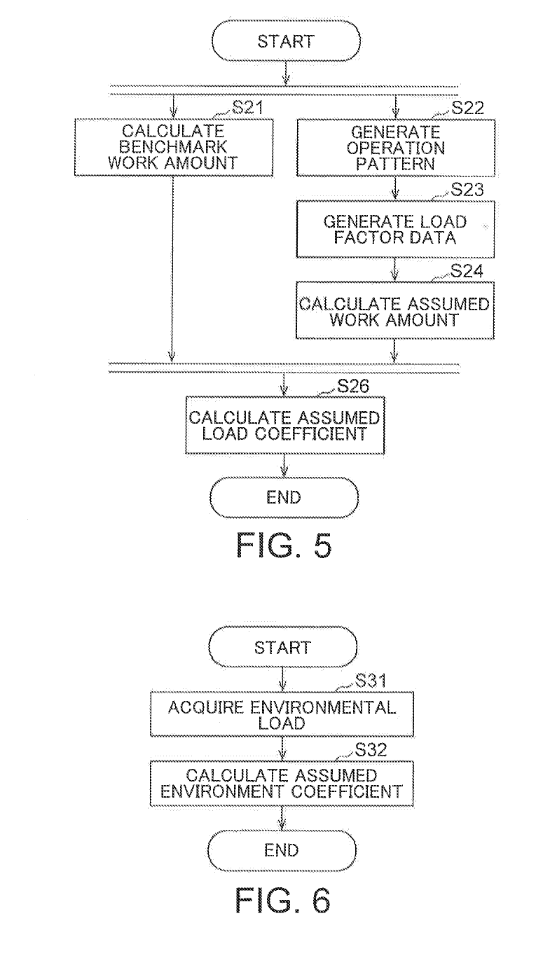

First, the assumed load coefficient calculation processing (step S20) will be described with reference to FIG. 5. When the assumed load coefficient calculation processing is started, the benchmark work amount and the assumed work amount are calculated in order or in parallel as shown in FIG. 5.

In step S21, the benchmark work amount calculator 14 calculates the benchmark work amount based on the design condition. When a unit time UT, a standard operation time per unit time sET, a standard load factor cLF, and a standard life time sLT are set as the design condition, a benchmark work amount bw is calculated as follows:

bw=(sET*cLF)*(sLT/UT)

For example, when the load factor is 70%, the target apparatus operates for eight hours a day, and the standard life time of the target apparatus is set as seven years, the benchmark work amount is as follows:

bw [h]=(8*0.7)*(365*7/1)=14308 [h]

In step S22, the operation pattern generator 8 generates the operation pattern based on the load condition. Note that, in the present embodiment, step S22 may be omitted.

Next, in step S23, the load factor data generator 9 generates the load factor data based on the load condition and the operation pattern. The load factor data is generated as, for example, a data sequence of the load factor for every unit hour.

Then, in step S24, the assumed work amount calculator 10 calculates the assumed work amount based on the load condition and the load factor data. When a unit time UT, a load factor per unit time vLF, and an operation time uLT are set as the load condition, an assumed work amount aw is calculated as follows:

aw=ΣvLFt*(uLT/UT)

In the above equation, vLFt is a load factor for every unit hour which is acquired from the load factor data.

For example, when the unit time is one day, the operation time is five years, and the load factor data is generated as a data sequence of a load factor for every one hour vLFt {0, 0, 0, 0, 0, 0, 0, 0, 0, 0.7, 0.5, 0.4, 1.0, 0.5, 0.4, 0.4, 0.9, 1.3, 1.2, 0.9, 0.5, 0.3, 0, 0}, the assumed work amount is as follows:

aw [h]=9*((365−52)*5/1)=14085 [h]

After step S21 and step S24, in step S26, the assumed load coefficient calculator 15 calculates the assumed load coefficient based on the benchmark work amount bw and the assumed work amount aw. An assumed load coefficient apc is calculated as follows:

apc=(aw*(sLT/uLT))/bw=(14085*(2555/1565))/14308=1.6071

This indicates that the operation load of the target apparatus operating in accordance with the set load condition is approximately 1.6 times of the operation load of the target apparatus operating in accordance with the design condition.

Next, the assumed environment coefficient calculation processing (step S30) will be described with reference to FIG. 6. When the assumed environment coefficient calculation processing is started, in step S31, the assumed environment coefficient calculator 6 acquires the environmental load of the target apparatus from the environmental load template based on the environmental condition.

Then, in step S32, the assumed environment coefficient calculator 6 calculates an assumed environment coefficient aec from the acquired environmental load and the benchmark value of the environmental load. Here, it is assumed that the assumed environment coefficient aec is 0.8. This indicates that the environmental load of the target apparatus operating under the set environmental condition is 0.8 times of the environmental load of the target apparatus operating under the benchmark environmental condition.

After the assumed load coefficient calculation processing (step S20) and the assumed environment coefficient calculation processing (step S30), the assumed life time calculator 16 calculates an assumed life time aft based on the assumed load coefficient apc and the assumed environment coefficient aec. The assumed life time alt is calculated as follows:

alt [year]=sLT/(apc*aec)=7/(1.6071*0.8)=5.4 [year]

The assumed life time alt calculated in this manner is stored in the apparatus configuration DB 1 by the apparatus configuration storage 2. Thereafter, when a target apparatus with an uncalculated assumed life time exists, the processing returns to step S20 and the processing to calculate the assumed life time of a next target apparatus is performed.

As described above, with the estimation device and the method according to the present embodiment, it is possible to estimate a life time based on operational conditions, such as an installation environment or an operation mode of a target apparatus. Therefore, it is possible to estimate a life time of an apparatus with high accuracy even at a planning stage of adding or replacing a target apparatus.

Furthermore, by using a life time estimated by the estimation device and the method according to the present embodiment, it is possible to accurately estimate life cycle costs of a target apparatus. Consequently, it is possible to improve determination accuracy of a design and investment effectiveness at a planning stage of reconstructing a building or replacing equipment. Moreover, it is useful for a device to estimate investment effect in a capital investment, a device to make a maintenance plan, and the like.

### Second Embodiment

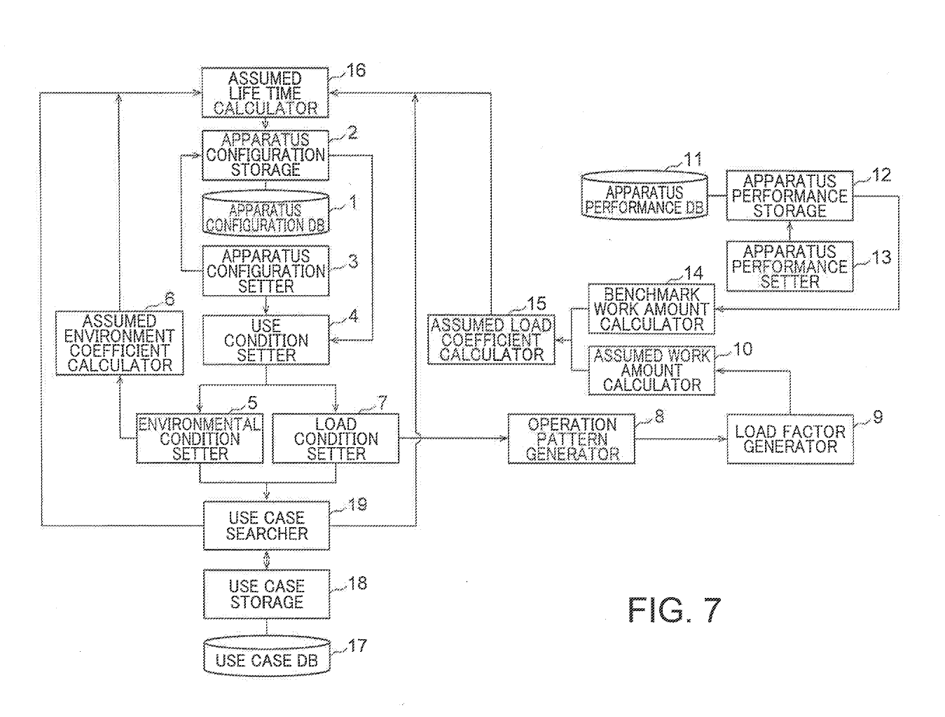

An estimation device and a method according to a second embodiment will be described with reference to FIGS. 7 to 9. The estimation device and the method according to the present embodiment estimate a life time of a target apparatus by using results data of the target apparatus or other apparatus. FIG. 7 is a block diagram showing a functional configuration of the estimation device according to the present embodiment. As shown in FIG. 7, the estimation device according to the present embodiment includes a use case DB 17, a use case storage 18, and a use case searcher 19. These functional configurations are implemented by a computer device 100. The other configurations are the same as the first embodiment.

The use case DB 17 is a storage medium which stores a use case. The use case is data in which information, such as a use condition, an environmental condition, a load condition, an apparatus configuration, apparatus performance, a real environment coefficient, a real load coefficient, a benchmark work amount, an operation pattern, an ID, and load factor data of an apparatus, is associated with each execution unit or each apparatus. The real environment coefficient and the real load coefficient are the real environment coefficient and load coefficient which are calculated based on results data of the apparatus. In the use case DB 17, it is preferable to manage the use case by using, for example, an application purpose, an application size, a standard using hour, and location characteristics as a key. Note that, a method for calculating the real environment coefficient and the real load coefficient will be described in a third embodiment.

The use case storage 18 acquires the information from the use case DB 17 and store the information in the use case DB 17. The use case storage 18 stores, for example, the use case in the use case DB 17. Furthermore, the use case storage 18 may include a function to extract the use case which matches search criteria.

The use case searcher 19 searches the use case DB 17 for the use case similar to the use condition, the environmental condition, and the load condition of the target apparatus. Furthermore, the use case searcher 19 acquires the real environment coefficient and the real load coefficient included in the found use case. The real environment coefficient and the real load coefficient acquired by the use case searcher 19 can be used to calculate an assumed life time.

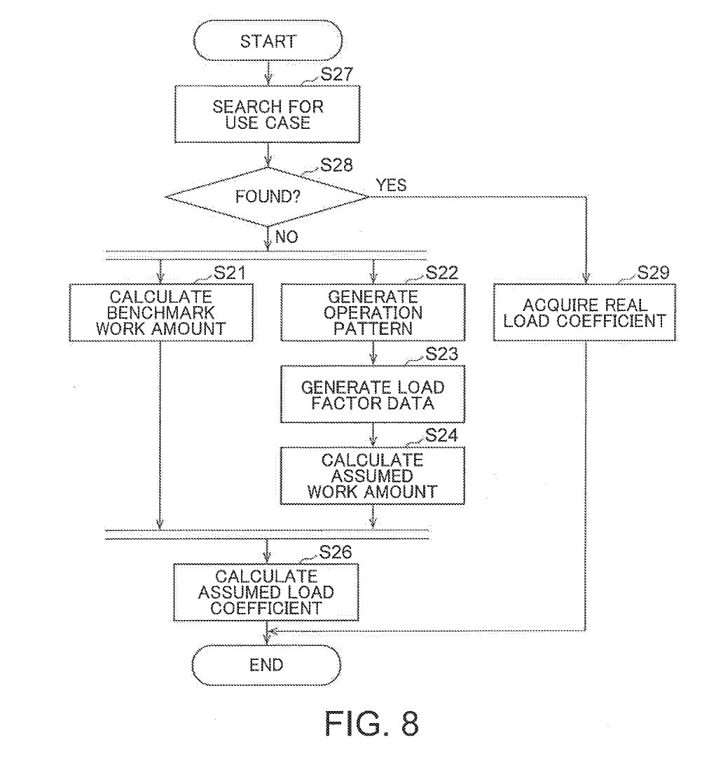

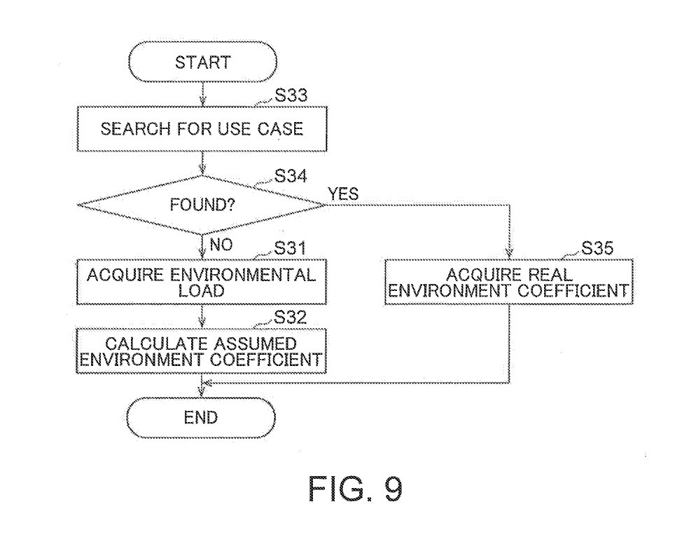

Next, the operation of the estimation device according to the present embodiment will be described with reference to FIGS. 8 and 9. FIG. 8 is a flowchart showing assumed load coefficient calculation processing (step S20) in the present embodiment. In FIG. 8, steps S21 to S26 are the same as the first embodiment.

When the assumed load coefficient calculation processing is started, first, in step S27, the use case searcher 19 acquires the use condition and the load condition of the target apparatus and searches the use case DB 17 for the use case similar to the acquired use condition and load condition.

When the similar use case has not been found (NO in step S28), the processing proceeds to step S21. Thereafter, in step S26, an assumed load coefficient calculator 15 calculates an assumed load coefficient, and the processing is ended. In this case, in step S40, an assumed life time calculator 16 calculates the assumed life time by using the assumed load coefficient.

On the other hand, when the similar use case has been found (YES in step S28), the processing proceeds to step S29. In step S29, the use case searcher 19 acquires the real load coefficient of the found use case, and the processing is ended. In this case, in step S40, the assumed life time calculator 16 calculates the assumed life time by using the real load coefficient acquired by the use case searcher 19 instead of the assumed load coefficient.

FIG. 9 is a flowchart showing assumed environment coefficient calculation processing (step S30) in the present embodiment. In FIG. 9, steps S31 and S32 are the same as the first embodiment.

When the assumed environment coefficient calculation processing is started, first, in step S33, the use case searcher 19 acquires the use condition and the environmental condition of the target apparatus and searches the use case DB 17 for the use case similar to the acquired use condition and environmental condition.

When the similar use case has not been found (NO in step S34), the processing proceeds to step S31. Thereafter, in step S32, an assumed environment coefficient calculator 6 calculates an assumed environment coefficient, and the processing is ended. In this case, in step S40, the assumed life time calculator 16 calculates the assumed life time by using the assumed environment coefficient.

On the other hand, when the similar use case has been found (YES in step S34), the processing proceeds to step S35. In step S35, the use case searcher 19 acquires the real environment coefficient of the found use case, and the processing is ended. In this case, in step S40, the assumed life time calculator 16 calculates the assumed life time by using the real environment coefficient acquired by the use case searcher 19 instead of the assumed environment coefficient.

As described above, with the estimation device and the method according to the present embodiment, it is possible to estimate a life time of a target apparatus by using results data of a use case similar to a use condition, an environmental condition, a load condition, and the like.

### Third Embodiment

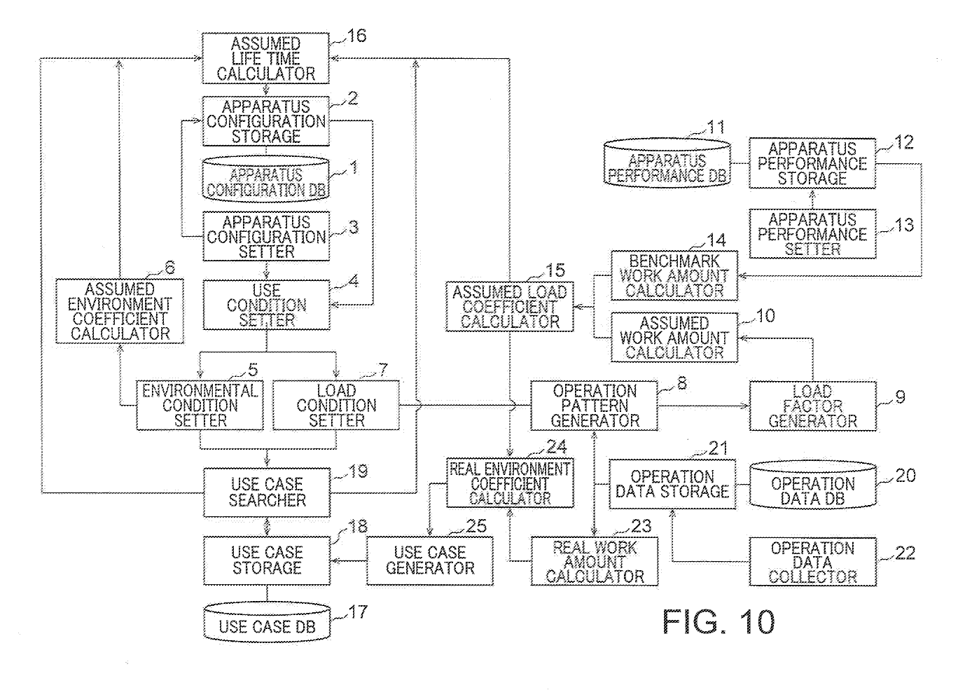

An estimation device and a method according to a third embodiment will be described with reference to FIGS. 10 to 13. The estimation device and the method according to the present embodiment include a unit to generate a use case including a real environment coefficient and a real load coefficient. FIG. 10 is a block diagram showing a functional configuration of the estimation device according to the present embodiment. As shown in FIG. 10, the estimation device according to the present embodiment further includes an operation data DB 20, an operation data storage 21, an operation data collector 22, a real work amount calculator 23, a real environment coefficient calculator 24, and a use case generator 25. These functional configurations are implemented by a computer device 100. The other configurations are the same as the second embodiment.

The operation data DB 20 is a storage medium which stores operation data as results data of a real operation mode or an installation environment of an apparatus. The operation data is, for example, but is not limited to, a load condition, an environmental condition, a use condition, an apparatus configuration, apparatus performance, and an operation pattern of an arbitrary apparatus including a target apparatus.

The operation data storage 21 acquires the information from the operation data DB 20 and store the information in the operation data DB 20. The operation data storage 21 may include a function to extract the operation data which matches search criteria.

The operation data collector 22 communicates, by wire or wireless, with one or more apparatuses which are collection targets of the operation data and collects the operation data. The operation data collected by the operation data collector 22 is stored in the operation data DB 20 by the operation data storage 21.

The real work amount calculator 23 calculates a real work amount based on the operation data stored in the operation data DB 20. The real work amount is a real work amount of the apparatus during the lifetime. Therefore, when a lifetime, that is, a real life time of an apparatus is known, the real work amount is calculated. The real life time is acquired based on maintenance events, such as occurrence of abnormality or malfunction, and exchange or repair of the apparatus. The real work amount is calculated as a cumulative load factor during the real life time.

In the present embodiment, in order to calculate a real load coefficient, an operation pattern generator 8 generates the operation pattern of the apparatus based on the operation data stored in the operation data DB 20. The operation pattern generator 8 generates the operation pattern by, for example, extracting a characteristic pattern from the operation data. Then, an assumed load coefficient calculator 15 calculates, by the above described method, an assumed load coefficient for the operation pattern generated by the operation pattern generator 8. The calculated assumed load coefficient is the load coefficient calculated by the actual operation data and is the real load coefficient of the apparatus.

The real environment coefficient calculator 24 calculates a real environment coefficient based on the real work amount calculated by the real work amount calculator 23 and the real load coefficient calculated by the assumed load coefficient calculator 15. The method for calculating the real environment coefficient will be described later.

The use case generator 25 generates a use case. The use case generator 25 associates, with each execution unit or each apparatus, information, such as a use condition, an environmental condition, a load condition, an apparatus configuration, apparatus performance, a real environment coefficient, a real load coefficient, a benchmark work amount, an operation pattern, an ID, a load factor data of the apparatus for which the real environment coefficient is calculated by the real environment coefficient calculator 24. Then the use case generator 25 structuralizes the information in an expression form of the use case DB 17, and thereby generates the use case. Various conditions, such as the use condition, the environmental condition, and the load condition, included in the use case may be set by a user, or acquired from a prepared template or operation data. The use case generated by the use case generator 25 is stored in the use case DB 17 by the use case storage 18.

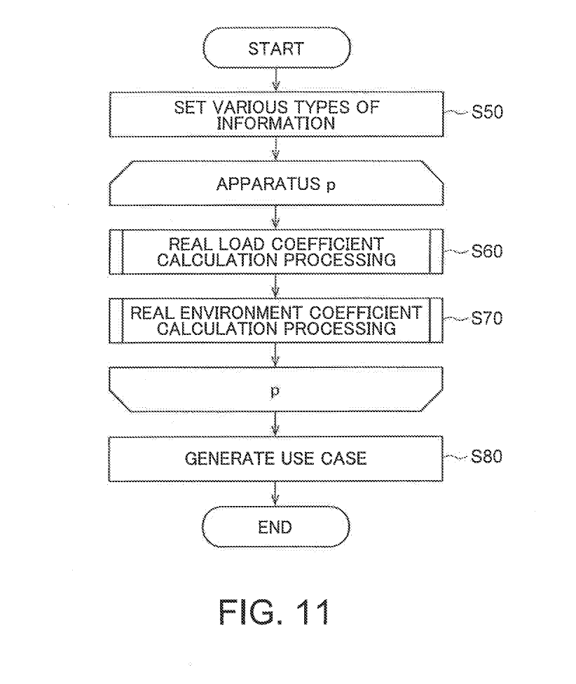

Next, the operation of the estimation device according to the present embodiment will be specifically described with reference to FIGS. 11 to 13. FIG. 11 is a flowchart showing a method for generating the use case by the estimation device according to the present embodiment.

First, in step S50, various types of information are set. In other words, the use case generator 25 sets the use condition, the environmental condition, the load condition, the apparatus configuration, and the apparatus performance of the use case.

After the settings, real load coefficient calculation processing (step S60), and real environment coefficient calculation processing (step S70) are performed. The processing from steps S60 to S70 is loop processing, and when a plurality of apparatuses which generates the use case exists, the processing is performed to all of the apparatuses.

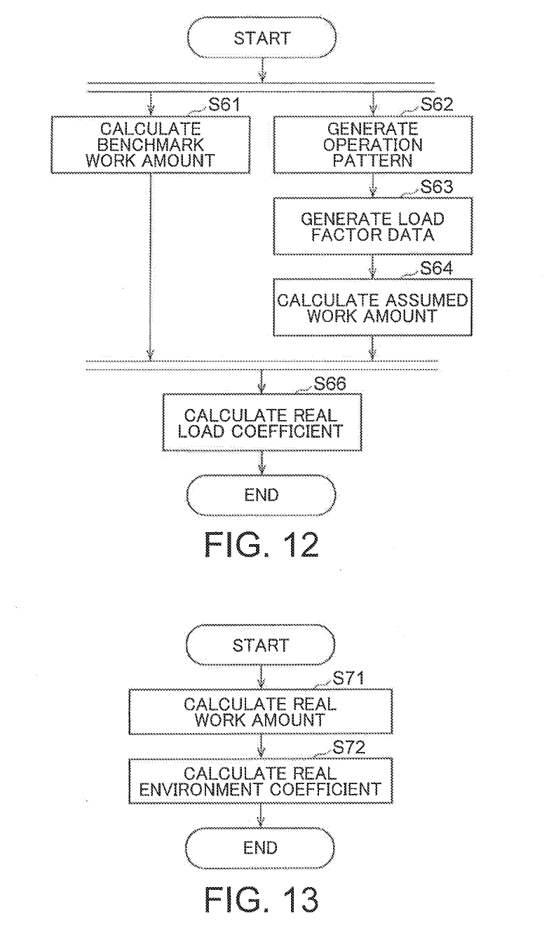

First, the real load coefficient calculation processing (step S60) will be described with reference to FIG. 12. When the real load coefficient calculation processing is started, a benchmark work amount and an assumed work amount are calculated in order or in parallel as shown in FIG. 12.

In step S61, a benchmark work amount calculator 14 calculates a benchmark work amount bw based on a design condition of the apparatus which generates the use case. The method for calculating the benchmark work amount bw has been described above.

In step S62, the operation pattern generator 8 extracts a characteristic pattern from the operation data and generates the operation pattern.

Next, in step S63, a load factor data generator 9 generates load factor data based on the operation pattern. The load factor data is generated as, for example, a data sequence of the load factor for every unit hour vLFt.

Then, in step S64, an assumed work amount calculator 10 calculates an assumed work amount aw based on the load factor. The method for calculating the assumed work amount aw has been described above.

After step S61 and step S64, in step S66, the assumed load coefficient calculator 15 calculates a real load coefficient rpc (=assumed load coefficient apc) based on the benchmark work amount bw and the assumed work amount aw. The method for calculating the real load coefficient rpc is the same as the method for calculating the above assumed load coefficient.

Next, the real environment coefficient calculation processing (step S70) will be described with reference to FIG. 13. When the real environment coefficient calculation processing is started, in step S71, the real work amount calculator 23 calculates a real work amount rw based on the operation data. When a unit time UT, a load factor per unit time vLF, and a real life time rLT are acquired from the operation data, the real work amount rw is calculated as follows:

rw=ΣvLFt*(rLT/UT)

In the above equation, vLFt is a load factor for every unit hour which is acquired from the operation data.

For example, when the unit time UT is one day, the real life time rLT is 1408 days, and the load factor is acquired as a data sequence of vLFt {0, 0, 0, 0, 0, 0, 0, 0, 0, 0.7, 0.5, 0.4, 1.0, 0.5, 0.4, 0.4, 0.9, 1.3, 1.2, 0.9, 0.5, 0.3, 0, 0}, the real work amount rw is as follows:

rw [h]=9*1408/1=12676.5 [h]

Then, in step S72, the real environment coefficient calculator 24 calculates a real environment coefficient rec based on the real load coefficient rpc, the real work amount rw, and the benchmark work amount bw. The real environment coefficient rec is calculated, for example, as follows:

rec=(bw/rw)/rpc

This is because it is considered that the differences between the benchmark work amount bw and the real work amount rw is caused by the operation load and the environmental load on the apparatus.

For example, in the case of bw=14308 [h], rw=12676.5 [h], and rpc=1.6071, the real environment coefficient rec is as follows:

rec=(14308/12676.5)/1.6071=0.7023

Thereafter, in step S80, the use case generator 25 generates the use case. The generated use case is stored in the use case DB 17 and used to calculate the assumed life time.

As described above, with the estimation device and the method according to the present embodiment, it is possible to calculate a real environment coefficient and a real load coefficient from operation data of an apparatus. Thus, it is possible to generate and use a use case to calculate an assumed life time.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A life time estimation device comprising:
a benchmark work amount calculator configured to calculate a benchmark work amount of a target apparatus based on a design condition;
an assumed work amount calculator configured to calculate an assumed work amount of the target apparatus based on a load condition;
an assumed load coefficient calculator configured to calculate an assumed load coefficient indicating a degree of an operation load on the target apparatus based on the benchmark work amount and the assumed work amount;
an assumed environment coefficient calculator configured to calculate an assumed environment coefficient indicating a degree of an environmental load on the target apparatus based on an environmental condition; and
an assumed life time calculator configured to calculate an assumed life time of the target apparatus based on the assumed load coefficient and the assumed environment coefficient.

2. The device according to claim 1, wherein the benchmark work amount is a cumulative load factor of the target apparatus during a life time set as the design condition.

3. The device according to claim 1, wherein the assumed work amount is a cumulative load factor of the target apparatus operating in accordance with the load condition.

4. The device according to claim 1, wherein the assumed load coefficient is a ratio of the benchmark work amount to the assumed work amount.

5. The device according to claim 1, wherein the environmental condition includes at least one of a location environment and an operation environment of the target apparatus.

6. The device according to claim 1, wherein the assumed environment coefficient is calculated based on a real environment coefficient indicating a degree of a real environmental load on another apparatus.

7. The device according to claim 6, wherein the real environment coefficient is calculated based on a real work amount and a real load coefficient which are calculated from operation data of the another apparatus.

8. The device according to claim 6, further comprising a use case searcher configured to search, from a use case including the real environment coefficient, for the use case similar to the environmental condition of the target apparatus.

9. The device according to claim 8, further comprising a use case generator configured to generate the use case.

10. A life time estimation method comprising:
calculating a benchmark work amount of a target apparatus based on a design condition;
calculating an assumed work amount of the target apparatus based on a load condition;
calculating an assumed load coefficient indicating a degree of an operation load on the target apparatus based on the benchmark work amount and the assumed work amount;
calculating an assumed environment coefficient indicating a degree of an environmental load on the target apparatus based on an environmental condition; and
calculating an assumed life time of the target apparatus based on the assumed load coefficient and the assumed environment coefficient.
